(19) United States
(12) Patent Application Publication
(10) Pub. No.: US 2011/0074168 A1
(43) Pub. Date: Mar. 31, 2011

(54) MOTOR VEHICLE DOOR LOCK

(75) Inventors: Thorsten Bendel, Oberhausen (DE); Claus Topfer, Sindelfingen (DE); Winfried Schlabs, Bochum (DE)

(73) Assignee: Kiekert Aktiengesellschaft, Heiligenhaus (DE)

(21) Appl. No.: 12/994,108

(22) PCT Filed: Apr. 24, 2009
(86) PCT No.: PCT/DE2009/000572

§ 371 Date: Dec. 15, 2010

(30) Foreign Application Priority Data
May 30, 2008 (DE) 20 2008 007 310.3

(51) Int. Cl. E05C 1/06

(52) U.S. Cl. 292/144

(57) ABSTRACT

A motor vehicle door lock, comprising a locking mechanism (1, 2), and a closing/opening device (3 to 7) having a drive, wherein the closing/opening device (3 to 7) acts on the locking mechanism (1, 2), and wherein-the closing/opening device (3 to 7) contains an interposed damping element (16).

### FIELD OF THE INVENTION

The invention relates to a motor vehicle door lock, comprising a locking mechanism and a closing/opening device having a drive, wherein the closing/opening device acts on the locking mechanism closing/opening device.

### BACKGROUND OF THE INVENTION

Closing/opening devices for motor vehicle door locks have in the past been predominantly used in expensive cars. Reference is in this context made to EP 1 319 780 A1, providing a motorized closing device for a bonnet or door, using a conventional electric motor. This means that upon reaching a certain operating position, in most cases the intermediate closed position, the locking mechanism is moved to its end position or fully closed position. This provides a particularly comfortable operation as an operator only has to move the door or bonnet into the intermediate closed position after which the closing device completes the closing operation.

Also, so-called opening aids are known that ensure that a respective locking mechanism of the motor vehicle door lock is opened by a motor. An example of such an opening aid is disclosed in DE 10 2004 052 599 A1. In this case, too, the primary aim is to enhance the comfort of operation.

The known closing/opening devices are generally in direct contact with the locking mechanism which in turn is normally accommodated in a frame box of the motor vehicle door lock. As the frame box is generally directly bolted to the respective vehicle door, any noises of the drive of the closing/opening device are transmitted onto the motor vehicle as structure-borne noise. As such a motor vehicle door generally contains more or less large cavities, there is the risk of such noises being amplified by respective resonances. This is disadvantageous as normally the closing/opening devices aim to achieve a higher level of operating comfort. Where such an operating comfort is coupled with an additional or unwanted noise level, customers will regard this as an overall negative experience despite of the improved ease of operation. The invention aims to remedy this.

### SUMMARY OF THE INVENTION

The invention is based on the technical problem of further developing such a motor vehicle door lock in such a way that whilst the ease of comfort is maintained, the noise level is reduced.

In order to solve this technical problem, a generic motor vehicle door lock is provided in which the closing/opening device contains an interposed (acoustic) damping element.

According to the invention this damping element within the closing/opening device first of all provides an acoustic decoupling between an obligatory motor of the closing/opening device and the other parts. It has proven to be advantageous for the damping element to be made predominantly from an elastomer or to at least contain such an elastomeric plastic material for acoustic decoupling.

In this context it is also recommended for the said damping element or the elastomer used at this point to be designed in such a way that frequencies generated by the said motor or respective electric motor are effectively suppressed. If the said motor operates, for instance, at 3000 rpm this corresponds to a frequency of 50 Hz that must be particularly attenuated in the example. This means that the elastomer must be selected and designed in such a way that, in particular, frequencies generated by the motor are effectively attenuated. Naturally, also other interpretations are possible.

In general, the design is such that the damping element transfers rotary movements of the said motor of the drive onto a downstream actuator. The transfer of the rotary movements with the aid of the damping element can either be direct or indirect. In the first option, the damping element is advantageously integrated in a drive train of the motor. In the latter option, the damping element generally combines two parts of the drive train of the motor.

Where the damping element is integrated in the drive train of the motor and the rotary movements are consequently directly transferred from the motor to the actuator, it is recommended for the damping element to be designed as a claw coupling. This claw coupling generally consists of two coupling elements containing claws or recesses, of which at least one is made from elastomer. Where the damping element connects two separate parts of the drive train of the motor that are in most cases separate from each other and thus transfers rotary movements of the motor indirectly onto the downstream actuator, it has proven to be advantageous for the damping element to be designed as a drive belt. Alternatives used are generally drive belts and couplings. It would, however, also be possible to combine both options.

For the drive, a linear drive has proven to be particularly effective. In this case the actuator is preferably a linear actuator. Generally, the drive comprises at least the said motor or electric motor and the actuator or linear actuator.

A particularly compact and functional embodiment is characterized by the motor and the actuator being arranged at an angle and, in particular, at right angles to each other. In this case the drive train of the motor or its drive shaft generally contains a worm gear connected to it in a rotationally fixed manner, which in turn meshes with a worm wheel driving the actuator or the linear actuator. Naturally it is also possible and lies within the scope of the invention not to use such an interposed worm gear drive between the motor and the actuator.

The actuator or the linear actuator generally comprises a spindle and a spindle element. By rotating the spindle it can be achieved that the spindle element positioned on said spindle can be moved to and fro in linear direction depending on the direction of rotation. This linear movement of the spindle element is only used for the closing/opening movement, as described in more detail in the description of the figures.

The result is a motor vehicle door lock containing a closing/opening device, not only allowing a comfortable operation of a respective vehicle door but also offering a particular low-noise operation. The invention achieves this by providing the closing/opening device with an interposed damping element made preferably from elastomeric plastic. These are the main advantages.

### BRIEF DESCRIPTION OF THE DRAWINGS

Below, the invention is explained in more detail with reference to exemplary drawings showing only one embodiment, as follows:

FIG. 1 shows a section of the motor vehicle door lock of the invention;

FIG. 2 shows the object of FIG. 1 in its installed position;

FIG. 3 shows a first embodiment of the object shown in FIGS. 1 and 2 with an interposed damping element; and

FIG. 4 shows a different version of the damping element of FIG. 3.

Other features and advantages of the present invention will become apparent from the following detailed description, taken in conjunction with the accompanying drawings which illustrate, by way of example, the principles of the invention.

### DETAILED DESCRIPTION OF THE INVENTION

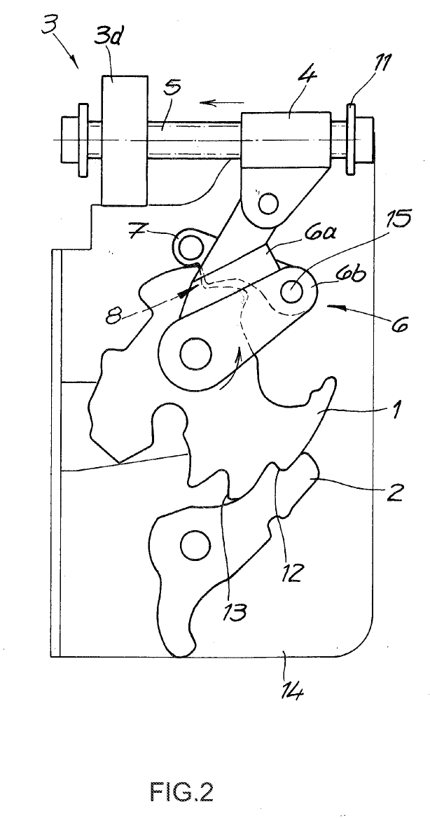

FIG. 2 shows a motor vehicle door lock in its installed position, as usual containing a locking mechanism 1, 2 comprising a rotary catch 1 and a respective pawl 2. A closing/opening device 3 to 7 is assigned to the locking mechanism 1, 2 with said closing/opening device being in this case a closing aid 3 to 7 and acting on the locking mechanism 1, 2 in order to close it.

For this purpose, the closing/opening device or closing aid 3 to 7 contains a drive 3, 4, 5, which is a linear drive 3, 4, 5 in the embodiment example. The linear drive 3, 4, 5 mainly consists of a motor 3a with a drive shaft 3b and a linear actuator 4, 5 acting thereon. In the embodiment, although the invention is not limited to this, the linear drive 3, 4, 5 between the motor 3a and the linear actuator 4, 5 also contains an interposed gear 3c, 3d being a worm gear 3c, 3d in the embodiment. Together, the motor 3a including the drive shaft 3b and the gear 3c, 3d form a motorized drive 3, acting upon the linear actuator 4, 5 in a rotary manner.

The linear actuator 4, 5 in turn comprises a spindle 5 and a spindle element 4 moving linearly to and fro on the spindle 5. The spindle 5 is in this case a threaded spindle 5, whilst the spindle element 4 is a spindle nut 4.

As a whole, the linear drive 3, 4, 5 acts directly or indirectly on the closing/opening element 7, which is a closing pawl 7 in the embodiment, engaging in a contour 8 of the locking mechanism 1, 2. In the embodiment, the contour 8 is formed on the outside of the rotary catch 1 so that the closing pawl 7 interacts with the respective contour 8 on the rotary catch 1.

The basic design also includes a lever 6 with the aid of which the linear drive 3, 4, 5 acts upon the closing/opening element or the closing pawl 7. The closing/opening device or closing aid 3 to 7 thus comprises a linear drive 3, 4, 5, the lever 6 and the closing pawl 7. The linear drive 3, 4, 5 in turn comprises the motorized drive 3 and the linear actuator 4, 5.

In the embodiment, the lever 6 consists of two lever parts 6a, 6b. One lever part 6a is a spindle part 6a and pivotally connected to the spindle element or spindle nut 4. The other lever part 6b is, by contrast, designed as a pawl lever part 6b and is, on one hand, mounted on the same axis as the rotary catch 1 and, on the other hand, pivotally connected to the closing/opening element or, in the embodiment, to the closing pawl 7.

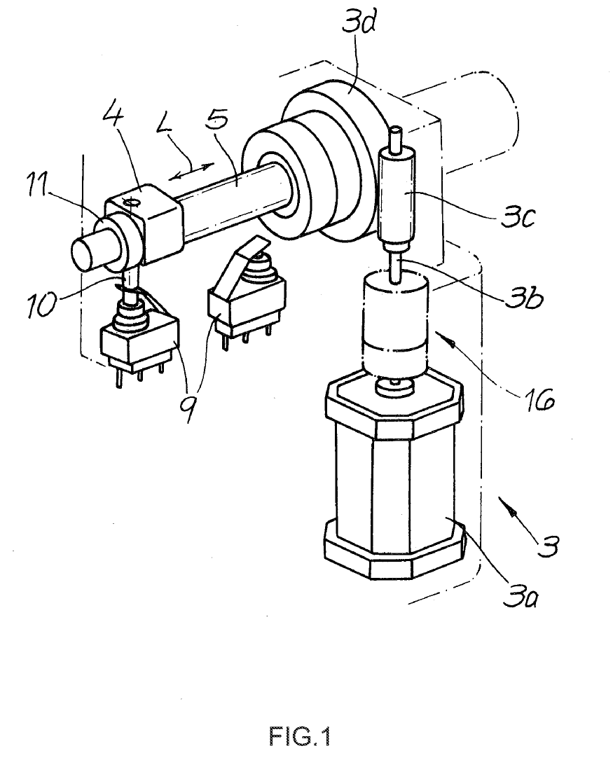

Finally, FIG. 1 shows two position sensors 9, acted upon by means of a probe tip 10 on the spindle nut 4 and that can thus stop or reverse the direction of the motor 3a via, for instance, a control unit, not shown in the figure, as the motor or electric motor 3a is a compact electric motor 3a turning in both directions. The shown outer bearing buffers 11 ensure that the spindle 5 or the spindle element or spindle nut 4 can only be moved to and fro in linear direction L along a set distance defined by the outer bearing buffers 11.

The device functions as follows. In order to move the rotary catch 1 with the pawl 2 engaged in the so-called intermediate closed position 12 as shown in FIG. 2 to the fully closed position, in which the pawl 2 engages in a primary position 13 on the rotary catch 1, it is necessary for the closing pawl 7, engaging in the contour 8 of the rotary catch 1, to rotate the rotary catch 1 counterclockwise in the example, as indicated by the rotational arrow in FIG. 2. The invention achieves this by moving the spindle element or the spindle nut 4 in FIG. 2 to the left. To achieve this, the motor or electric motor 3a must start the respective rotation of the spindle or threaded spindle 5. For this purpose the drive shaft 3b of the motor 3a contains a worm gear 3c, engaging in a worm wheel 3d of the worm gear drive 3c, 3d. The worm wheel 3d is arranged on the same axis as the spindle 5 and connected to it in a rotationally fixed manner.

Rotation of the worm wheel 3d consequently directly causes the spindle 5 to rotate. As a result, the spindle element or the spindle nut 4 moves in the linear direction L or, depending on the direction of rotation of the electric motor 3a, to the left when looking at FIG. 2, causing the rotary catch 1 to carry out the desired counterclockwise movement. As the spindle nut 4 moves to the left, the lever 6 follows this movement, causing the pawl lever part 6b to carry out a counterclockwise rotation, as it is practically fixed with one end on the same axis as the rotary catch 1 to a frame box 14, whilst the spindle lever part 6a and the spindle nut 4 are moved to the left. As the closing pawl 7 is pivotally connected to this other end or to the pawl lever part 6b at a mutual pivot point, the closing pawl 7 carries out the desired counterclockwise movement following the rotary catch 1 as the closing pawl 7 engages in the contour 8 on the rotary catch 1.

It is apparent that the linear actuator 4, 5 and the motor 3a are arranged at an angle to each other and that in the embodiment both the motor 3a and the linear actuator 4, 5 are connected to the frame box 14 or linked to it. It is generally also possible to position the linear drive 3, 4, 5 completely separately from the frame box 14 and thus to define a separate module for this purpose. The connection between the linear drive 3, 4, 5 and the locking mechanism 1, 2 or the lever 6 implemented unchanged at this point, can in this case be provided by a transfer element, being advantageously a Bowden cable or similar. This Bowden cable may engage in the spindle lever part 6a instead of the spindle nut 4. This is, however, not shown in the figure. Also not shown is the basic option of driving the spindle element 4 instead of the spindle 5 with the aid of the motor 3a.

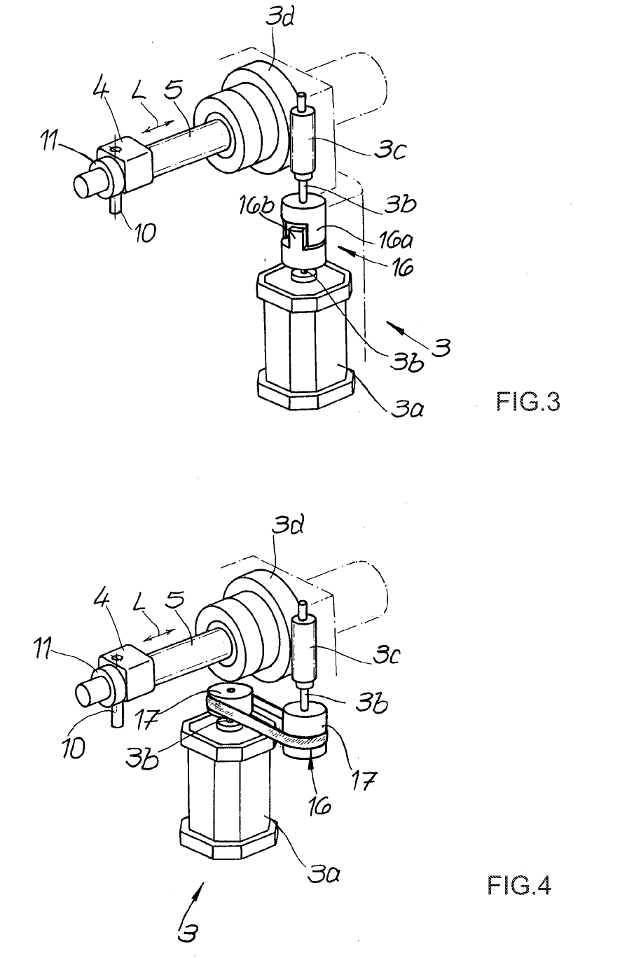

According to the invention, the closing/opening device 3 to 7 according to FIGS. 1 and 2 contains an interposed damping element or a coupling 16. FIGS. 3 and 4 show various designs of this damping element or of the coupling 16. In all designs, the damping element 16 is mainly made of an elastomer or an elastomeric plastic material. The damping element 16 is generally designed in such a way that any resonances generated by the motor or electric motor 3a, are attenuated as already described above.

The damping element 16 ensures in any case that the rotary movements of the motor 3a are transferred to the downstream actuator 4, 5 or the linear actuator 4, 5. This can be a direct transfer as shown in FIG. 3 in which the damping element 16 is integrated in a drive train of the Motors 3a. Alternatively, also an indirect transfer of the rotary movement is possible, as shown in FIG. 4. In this case, the damping element 16 connects to spatially separate components of the drive train of the motor 3a.

Where the damping element 16 is integrated in the drive train of the motor 3a, it is recommended that the damping element 16 is designed as a claw coupling 16a, 16b as shown in FIG. 3. Such a claw coupling 16a, 16b actually contains two coupling elements 16a, 16b, reciprocally engaging with axially uprising claws and corresponding recesses. At least one of the two coupling elements 16a, 16b is made from the said elastomer. The drive shaft 3b of the motor 3a consists incidentally of two parts, with one coupling element 16a being connected to one end and the other coupling element 16b to the other end. Both ends are coaxially disposed to each other. As already described, the unchanged implemented worm gear drive 3c, 3d ensures that the (attenuated) rotary movement of the motor 3a is transferred to the actuator or linear actuator 4, 5.

In the design shown in FIG. 4, offering indirect transfer of the rotary movement, the damping element 16 is designed as a drive belt 16. In this case, the drive shaft 3b of the motor 3a consists again of two parts, in which the end face pulleys 17 of the spatially separated parts are connected by the driving belt 16 or the damping element 16. In this way, the rotary movements of the motor 3a are again (attenuated) transferred to the worm gear 3c and then to the worm wheel 3d and the actuator 4, 5.—Finally, it is apparent that the motor 3a and the actuator 4, 5 are arranged at an angle to each other, in the embodiment of FIGS. 1 to 4 at right angles to each other, allowing for a particular compact design. The damping element 16 also allows the respective angle to be changed without problem, where necessary.

The figures do not show the option of designing individual parts of the closing/opening device 3 to 7 as a single part. The lever 6, the spindle element 4 and also the closing/opening element 7 can be wholly or partially designed as a single part.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

1. A motor vehicle door lock, comprising:
a locking mechanism (1, 2), and a closing/opening device (3 to 7) having a drive, wherein the closing/opening device (3 to 7) acts on the locking mechanism (1, 2), and wherein the closing/opening device (3 to 7) contains an interposed damping element (16).

2. The motor vehicle door lock according to claim 1, wherein the damping element (16) is predominantly made from an elastomer.

3. The motor vehicle door lock according to claim 1, wherein the damping element (16) transfers rotary movements of a motor (3a) of the drive (3, 4, 5) to as downstream actuator (4, 5).

4. The motor vehicle door lock according to claim 1, wherein the damping element (16) is designed as a drive belt 6) and/or claw coupling (16a, 16b).

5. The motor vehicle door lock according to claim 1, wherein the damping element (16) is integrated in a drive train of a motor (3a) of the drive (3, 4, 5).

6. The motor vehicle door lock according to claim 5, wherein the damping element (16) connects two components of the drive train of the motor (3a).

7. The motor vehicle door lock according to claim 1, wherein the drive (3, 4, 5) is designed as a linear drive (3, 4, 5).

8. The motor vehicle door lock according to claim 1, wherein the drive (3, 4, 5) comprises at least a motor (3a) and an actuator (4, 5).

9. The motor vehicle door lock according to claim 8, wherein the motor (3a) and the actuator (4, 5) are positioned at an angle and, in particular, at right angles to each other.

10. The motor vehicle door lock according to claim 8, wherein the actuator (4, 5) is a linear actuator (4, 5) and contains a spindle element (4).
